(19) United States
(12) Patent Application Publication
(10) Pub. No.: US 2025/0298939 A1
(43) Pub. Date: Sep. 25, 2025

(54) METHOD FOR GENERATING CUSTOM COMPRESSION GARMENT WITH CHAINMESH

(71) Applicant: Opensuit Corporation, Brooklyn, NY (US)

(72) Inventors: Owen Hoyt, Brookyn, NY (US); Christopher Knauth, Brookyn, NY (US); Kikimora Morozova, Brookyn, NY (US)

(21) Appl. No.: 19/083,232

(22) Filed: Mar. 18, 2025

Related U.S. Application Data
(60) Provisional application No. 63/567,022, filed on Mar. 19, 2024.

(51) Int. Cl. G06F 30/20; A41H 1/00; B33Y 50/00; B33Y 80/00

(52) U.S. Cl. CPC G06F 30/20; A41H 1/00; B33Y 50/00; B33Y 80/00

(57) ABSTRACT

One variation of a method includes: accessing a virtual mesh representing a target body part; downscaling the virtual mesh according to a manufacturing offset between primary and secondary links during additive manufacturing of a compression garment 100 corresponding to the virtual mesh; downscaling the virtual mesh according to a target compression for the compression garment; and constructing a network of tessellated cells intersecting a surface of the virtual mesh. This variation of the method also includes generating a model of the compression garment including: a constellation of virtual primary links, each virtual primary link defining a toroidal geometry and located within a tessellated cell; and a constellation of virtual secondary links, each virtual secondary link linking a pair of adjacent virtual primary links in the first constellation of virtual primary links and offset from surfaces of the pair of adjacent virtual primary links by the manufacturing offset.

### CROSS-REFERENCE TO RELATED APPLICATIONS

This Application claims the benefit of U.S. Provisional Application No. 63/567,022, filed on 19 Mar. 2024, which is incorporated in its entirety by this reference.

### TECHNICAL FIELD

This invention relates generally to the field of compression garments and, more specifically, to a new and useful method for generating custom compression garments with chainmesh.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method; and

FIG. 5 is a schematic representation of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

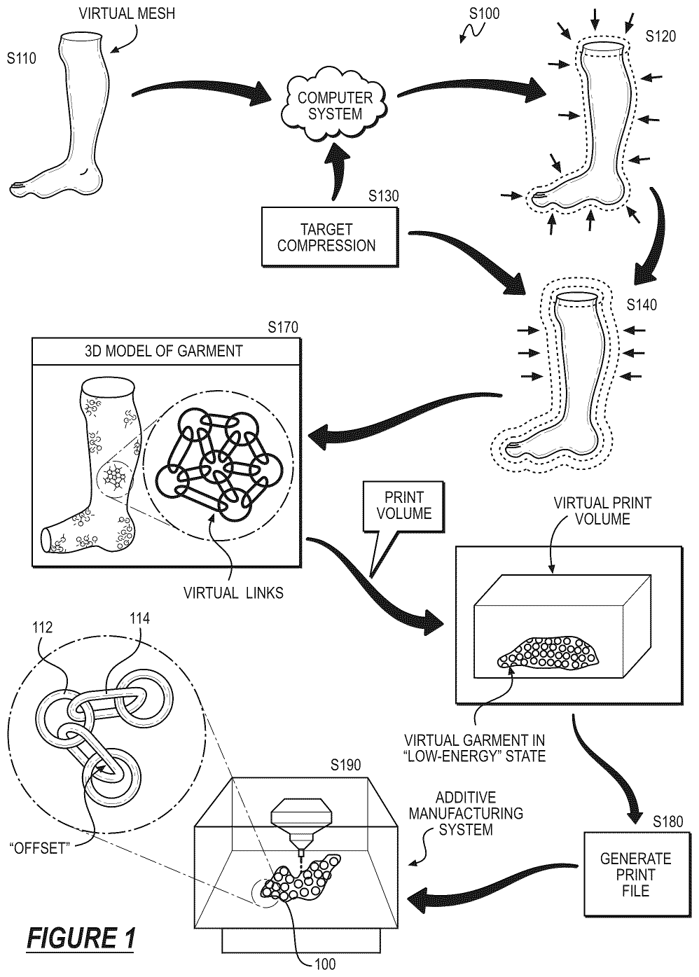

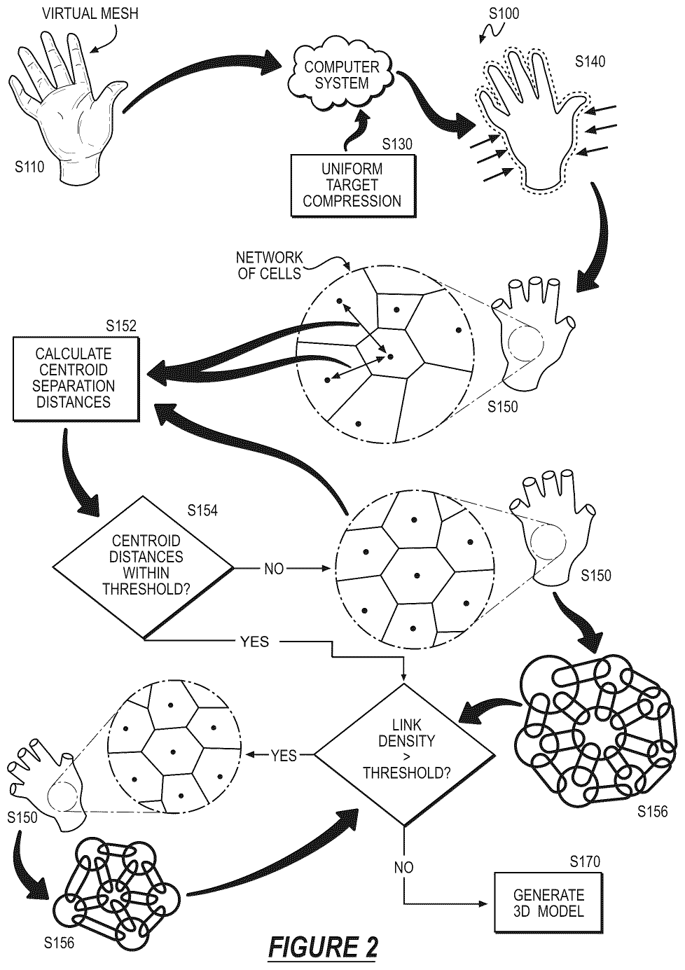

As shown in FIGS. 1 and 2, a method S100 includes: accessing a virtual mesh representing a target body part in Block S110; downscaling the virtual mesh, in three dimensions, according to a manufacturing offset between primary links and secondary links of a compression garment 100, corresponding to the virtual mesh, during additive manufacturing of the compression garment 100 in Block S120; calculating an approximate centerline of the virtual mesh in Block S124; accessing a target compression for the compression garment 100 in Block S130; and radially downscaling the virtual mesh, radially about the approximate centerline, according to the target compression in Block S140.

The method S100 further includes: constructing a network of tessellated cells intersecting a surface of the virtual mesh in Block S150; characterizing a set of distances between centroids of adjacent tessellated cells in the network of tessellated cells in Block S152; calculating a first proportion of the set of distances that exceed a threshold distance in Block S154; and, in response to the first proportion of the set of distances exceeding a threshold proportion, reconstructing the network of tessellated cells in Block S156.

The method S100 further includes generating a three-dimensional model of the compression garment 100 in Block S170, the three-dimensional model including: a first constellation of virtual primary links, each virtual primary link in the first constellation of virtual primary links defining a toroidal geometry, and located within a tessellated cell in the network of tessellated cells; and a second constellation of virtual secondary links, each virtual secondary link in the second constellation of virtual secondary links linking a pair of adjacent virtual primary links in the first constellation of virtual primary links, and defining a surface offset from surfaces of the pair of adjacent virtual primary links by the manufacturing offset.

### 1.1 Variation: Compression Garment Construction

As shown in FIGS. 1, 4, and 5, one variation of the method S100 includes: accessing a virtual mesh representing a target body part in Block S110; downscaling the virtual mesh, in three dimensions, according to a manufacturing offset between primary and secondary links of a compression garment, corresponding to the virtual mesh, during additive manufacturing of the compression garment 100 corresponding to the virtual mesh in Block S120; downscaling the virtual mesh, in two dimensions, based on a target compression for the compression garment 100 in Block S140; and constructing a network of tessellated cells intersecting a surface of the virtual mesh in Block S150.

This variation of the method S100 further includes generating a three-dimensional model of the compression garment 100 in Block S170, the three-dimensional model including: a first constellation of virtual primary links, each virtual primary link in the first constellation of virtual primary links defining a toroidal geometry, characterized by a primary equatorial plane intersecting and parallel to a surface of a tessellated cell in the first network of tessellated cells, and located within a tessellated cell in the network of tessellated cells; and a second constellation of virtual secondary links, each virtual secondary link in the second constellation of virtual secondary links linking a pair of adjacent virtual primary links in the first constellation of virtual primary links, and defining a surface offset from surfaces of the pair of adjacent virtual primary links by the manufacturing offset.

This variation of the method S100 also includes generating a print file representing the three-dimensional model of the compression garment 100, the print file executable by an additive manufacturing system to construct the compression garment 100, in Block S180.

### 1.2 Variation: Chainmesh Garment

As shown in FIGS. 1, 3, and 5, one variation of the method S100 includes: accessing a virtual mesh representing a target body part for generating a chainmesh garment in Block S110; accessing a target compression for the chainmesh garment in Block S130; downscaling the virtual mesh based on the target compression in Block S140; and defining a seam location on the virtual mesh in Block S174.

This variation of the method S100 further includes: generating a three-dimensional model of the chainmesh garment in Block S170, the three-dimensional model including: a first constellation of virtual primary links, each virtual primary link in the first constellation of virtual primary links flush with a surface of the virtual mesh; a second constellation of virtual secondary links, each virtual secondary link in the second constellation of virtual secondary links linking a pair of adjacent virtual primary links in the first constellation of virtual primary links; and a third constellation of virtual tertiary links, each virtual tertiary link in the third constellation of virtual tertiary links linked to primary links, in the first constellation of virtual primary links, proximal the seam location. This variation of the method S100 also includes additively manufacturing the chainmesh garment according to the three-dimensional model in Block S190.

### 2. Applications

Generally, the method S100 can be executed by a computer system (e.g., a remote computer system, a computer network, a remote server) in conjunction with an additive manufacturing system to transform a three-dimensional scan of a body part (e.g., a leg, a wrist, a torso) into a print file executable by an additive manufacturing system to print a custom “chainmail” garment (e.g., formed from polymer or metal): configured for donning on the body part; and configured to apply a controlled (e.g., uniform, planned non-uniform) compression to the body part when donned on the body part. For example, the method S100 can be executed by the computer system to transform a three-dimensional scan of a patient's foot and leg into a custom compression sock configured to apply a first target tension to the patient's calf, a second target tension to the patient's foot, and less tension to the patient's toes and ankle in order to yield reduced fatigue and greater mobility when the custom compression sock is worn by the patient. In another example, the method S100 can be executed by the computer system to transform a three-dimensional scan of an astronaut's body into a custom compression suit configured to apply different target tension across the astronaut's arms, legs, torso, and joints.

More specifically, the computer system can execute Blocks of the method S100: to access a virtual mesh (e.g., a virtual three-dimensional representation) representing a target body part for generating a compression garment; to downscale (e.g., shrink) the virtual mesh according to a post-printing expansion factor; to downscale the virtual mesh according to a target compression for the compression garment; to construct a constellation of tessellated cells on a surface of the virtual mesh, including a centroidal Voronoi tessellation, that define a pattern for arranging virtual links on the virtual mesh; to generate a three-dimensional model representing the compression garment and including a network of virtual links arranged on the virtual mesh according to the pattern; and to print the compression garment—represented in the three-dimensional model—including a network of real links corresponding to the network of virtual links.

In particular, the compression garment (or a “chainmesh” garment) may be worn by a user in various applications, such as: medical applications (e.g., increasing blood flow, reducing swelling, or post-surgical recovery); athletic support (e.g., muscle stabilization, fatigue reduction, or performance enhancement); and/or aerospace applications (e.g., maintaining blood circulation in high-gravity loading environments, providing structural support in pressurized suits, or providing mechanical counterpressure in non-pressurized suits in low ambient pressure environments). The compression garment includes a network of real, interconnected links formed in a custom cellular structure conforming to the features (e.g., contours) of the target body part. The network of real links can be: rigid when tensioned over the target body part to apply targeted compression; and flexible during donning and doffing to enable the user to easily arrange the compression garment over the target body part.

### 2.1 Compression Control

Generally, the compression garment can be downscaled (or “undersized”) relative to the target body part such that, during wear, the compression garment tensions over and exerts a targeted compression force on the target body part. More specifically, the compression garment can be undersized according to a target compression specified for the compression garment. Additionally, a particular region (e.g., a calf region) of the compression garment (e.g., a compression sock) can be undersized according to a regional target compression. For example, the target compression can be based on: a target flexibility or mobility (e.g., increased mobility in joint regions); a target rigidity (e.g., structural reinforcement in load-bearing areas); an intended garment application (e.g., post-surgical recovery) associated with the compression garment; and/or a compression garment type (e.g., a compression sock) of the compression garment.

In one application, the compression garment can be customized for the particular user by tailoring the network of links to conform to the anatomical features of the target body part. In particular, in this application, the computer system can: access a virtual mesh representing the target body part; downsize the virtual mesh according to the target compression for the compression garment; detect features (e.g., contours) of the target body part represented in the virtual mesh; and virtually construct a network of virtual links, arranged on the downsized virtual mesh, that align with the curvature and geometric variations of the target body part to achieve uniform contact and controlled compression distribution. Accordingly, the network of virtual links can define a pattern for constructing a network of real links forming the compression garment.

### 2.2 Printing and Garment Generation

An additive manufacturing system can then construct (i.e., print) the compression garment by constructing the network of real links represented by the network of virtual links. Therefore, the computer system can integrate anatomical contours into the construction of the compression garment to enhance fit, maintain consistent compression levels across varying surface geometries, and achieve structural integrity across the network of real links 110 while accommodating user-specific mobility and pressure distribution needs.

In one application, the computer system can identify a configuration of the three-dimensional model within a virtual print volume corresponding to the additive manufacturing system that: minimizes printing time by printing the compression garment to reduce unnecessary print head travel and layer transitions; reduces material waste by efficiently arranging the three-dimensional model within the virtual print volume; and preserves the structural integrity of the compression garment by maintaining spacing between links, preventing unintended fusion, and ensuring post-printing flexibility. In this application, the computer system can: virtually locate (e.g., collapse) a three-dimensional model of the compression garment within the virtual print volume in a low-energy state; and transmit a print file to the additive manufacturing system (e.g., a selective laser sintering (SLS) system) for printing the compression garment according to the low-energy state.

Accordingly, the compression garment: can be fabricated via the additive manufacturing system, such that the compression garment is “ready-to-wear” upon execution of the print file (i.e., without requiring additional post-processing); and can be rapidly printed on demand to accommodate individual user specifications. Therefore, the system enables cost-effective, sustainable manufacturing of custom compression garments that reduces material consumption and production time.

### 3. Compression Garment

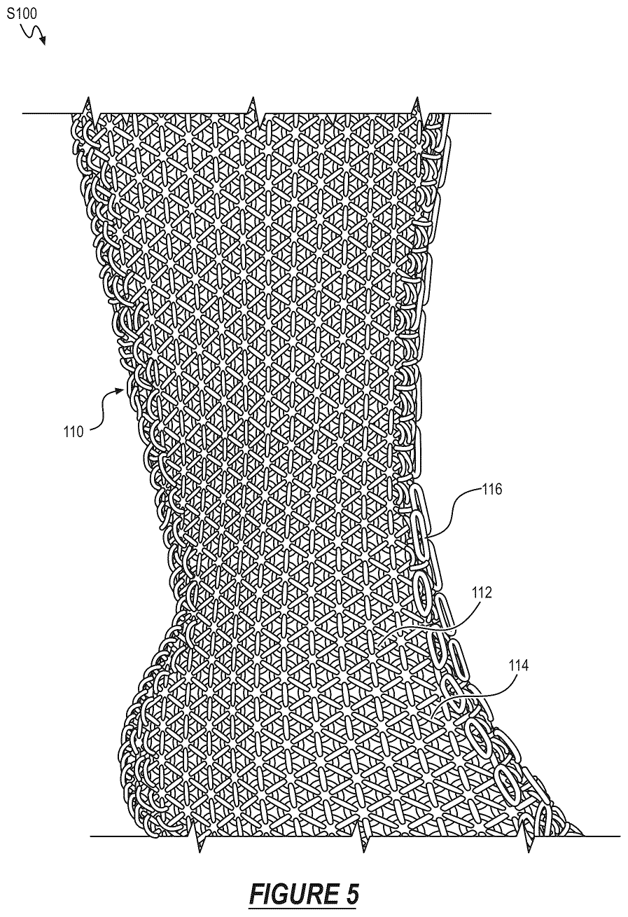

As shown in FIG. 5, a compression garment 100 is configured to: locate over a target body part (e.g., a lower leg, a torso, an elbow joint) of a user; and tension over the target body part to apply a controlled compression force. The compression garment 100 includes: a network of three-dimensional, interconnected links (hereinafter referred to as a “network of links 110”) defining a three-dimensional surface configured to contact (and conform to) a target body surface of the target body part; and a closure mechanism (e.g., a zipper, a dial-based tensioning system, a lace-based system) coupled to the network of links 110 at a seam location and configured to secure the compression garment 100 to the target body part.

The network of links 110 can form a custom cellular structure conformal to the target body part. In particular, when the compression garment 100 is donned over the target body surface, the network of links 110 conforms to the target body part and exerts controlled (or predictable, planned, designed, target) compression (e.g., hoop stress, hoop force) across the target body part. In particular, the network of links 110 can include: a constellation of primary links 112 (e.g., configured to lie flush with the target body surface); a constellation of secondary links 114 (e.g., configured to lie normal to the target body surface) coupling adjacent primary links 112; and a constellation of tertiary links 116 arranged proximal the seam location and configured to couple the closure mechanism to the network of links 110.

Furthermore, in specific regions of the compression garment 100, the geometry of secondary links 114 can be selected to achieve targeted mechanical properties. For example, the major radius of a secondary link 114 (e.g., its height relative to the primary links 112) can be selected to increase mechanical extensibility, such that the network of links 110 can accommodate localized expansion while maintaining overall compression integrity. Conversely, the minor radius (e.g., thickness) of a secondary link 114 can be selected to enhance structural rigidity in regions requiring additional reinforcement, such as load-bearing areas or regions prone to high mechanical stress. By selectively adjusting secondary link geometries, the computer system can tailor the mechanical response of the compression garment 100, such that compression and flexibility are distributed according to the functional needs of different regions of the target body part.

Each link in the network of links 110 can exhibit a link geometry (e.g., a toroidal geometry) and link dimensions (e.g., a link diameter) configured to enable localized control over compression distribution and garment flexibility. In particular, the link geometry and dimensions can be selected to achieve a target compression intensity and/or a target flexibility while maintaining structural integrity under tension.

Furthermore, the compression garment 100 exhibits a total garment surface area less than a body surface area of the target body surface. In particular, the total garment surface can be downscaled (i.e., relative to the target body surface) according to the target compression for the compression garment 100. By downscaling (or “undersizing”) the compression garment 100, the compression garment 100 can tension over the target body part to exert a controlled compression force while conforming to anatomical contours of the target body part.

### 4. Virtual Mesh

Block S110 of the method S100 recites accessing a virtual mesh representing a target body part. Generally, in Block S110, the computer system can access a virtual mesh representing a target body part for constructing a compression garment 100.

In one variation, the computer system can: access a set of images of a region of a body captured by a user (e.g., at a mobile device); compile the set of images into a virtual mesh; and crop the virtual mesh to constrain the virtual mesh to surfaces corresponding to the target body part. The computer system can then access a target compression for the compression garment 100.

### 5. Uniform Undersizing for Slack and Manufacturing Offset

Block S120 of the method S100 recites downscaling the virtual mesh, in three dimensions, according to a manufacturing offset (e.g., between 0.05 mm and 0.50 mm) between primary and secondary links of a compression garment, corresponding to the virtual mesh, during additive manufacturing of the compression garment 100 corresponding to the virtual mesh. Generally, in Block S120, the compression garment 100 can be downscaled (or “undersized”) to account for post-processing expansion of the network of links 110 (e.g., slack). In particular, the computer system can downscale the virtual mesh according to (e.g., proportional to) the manufacturing offset, wherein the manufacturing offset accounts for the minimum spacing required between primary and secondary links to prevent fusion during printing of the compression garment 100. Thus, the computer system can downscale the virtual mesh according to the manufacturing offset: to maintain proportions compatible with the target body part; to maintain the manufacturing offset across the network of links 110 to prevent unintended fusing of links during printing of the compression garment 100; and to generate a compression garment 100 that conforms to the target body part and exerts the target compression after post-printing expansion (i.e., during wear).

### 6. Target Compression

Block S130 of the method S100 recites accessing a target compression for the compression garment 100. Generally, the computer system can: access a target compression for the compression garment 100 in Block S130; and derive a configuration (or pattern) for a network of links 110 (i.e., links forming the compression garment 100) that yields the target compression.

### 6.1 Uniform Target Compression

In one implementation, the computer system can access a uniform, predefined target compression for the compression garment 100, such as based on a compression garment type of the virtual mesh. In particular, the computer system can: detect a compression garment type of the virtual mesh based on features (e.g., contours) of the virtual mesh; and access a predefined target compression for the compression garment 100 based on the compression garment type. For example, the computer system can: access a virtual mesh depicting a lower leg; detect a compression sock type of the virtual mesh based on contours of the lower leg represented in the virtual mesh; and access a predefined target compression of 30 mmHg for the compression sock type.

Additionally or alternatively, the computer system can access and/or receive a garment application type (e.g., an intended garment application), such as a medical application. The computer system can then implement methods and techniques described above to access a predefined target compression for the compression garment 100 based on the garment application type.

### 6.2 User-Specified Uniform Compression

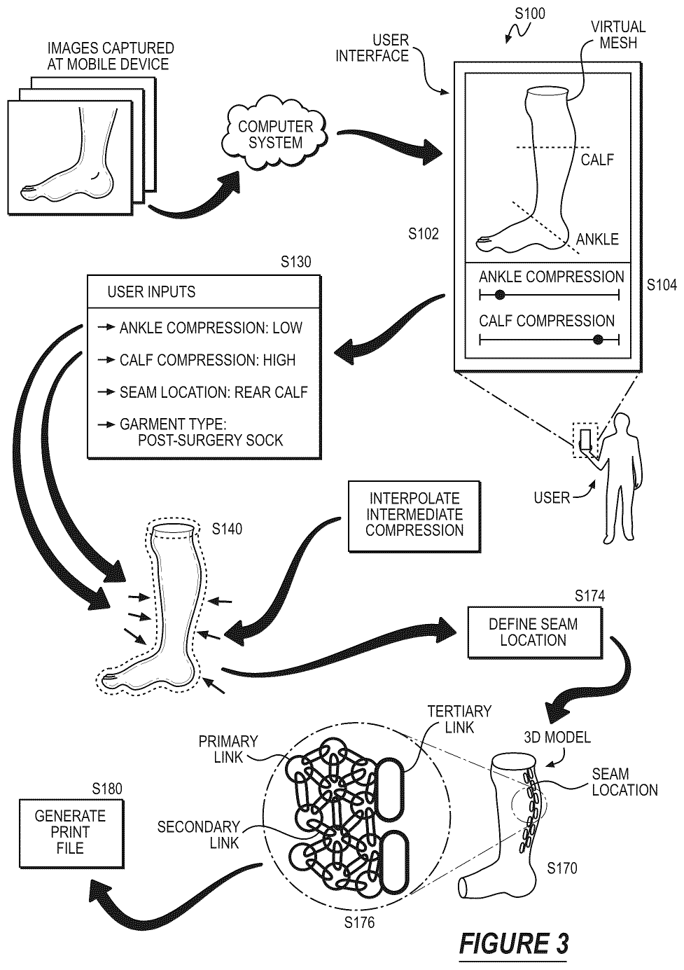

In one variation, as shown in FIG. 3, Blocks of the method S100 recite: rendering the virtual mesh via a user interface in Block S102; generating and transmitting a prompt to indicate the target compression for the virtual mesh via a user interface in Block S104; and receiving selection of the target compression for the virtual mesh from a user in Block S130. In this variation, in Block S130, the computer system can access and/or receive a user-specified target compression for the compression garment 100. In one example, the computer system: renders the virtual mesh via the user interface; prompts the user to select between predefined target compression profiles (e.g., mild, moderate, firm); and receives selection of a target compression, corresponding to a predefined target compression profile, from the user.

### 6.3 Non-uniform Compression

In one variation, the computer system can access a predefined target compression for a particular region of the compression garment 100 based on a target mobility for the region. For example, the computer system can: access a virtual mesh depicting an elbow joint; detect a compression sleeve type of the virtual mesh based on contours of the elbow joint represented in the virtual mesh; access a first predefined target compression of 15 mmHg for a forearm region of the compression sleeve type; and access a second predefined target compression of 10 mmHg for an elbow region of the compression sleeve type (e.g., to enable increased mobility at the elbow).

In another variation, the computer system can implement methods and techniques described above to receive a user-specified target compression for a particular region of the compression garment 100. In one example, the computer system: accesses a virtual mesh representing a lower leg; renders a set of predefined compression zones (e.g., calf region, ankle region) on the virtual mesh, each predefined compression zone in the set of predefined compression zones adjacent a slider bar; and, at each predefined compression zone in the set of predefined compression zones, prompts the user to adjust a slider bar to a target compression for the predefined compression zone. The computer system then: receives selection of one or more target compression values for the compression garment 100; constructs a colored gradient, representing a compression gradient of the compression garment 100 (e.g., with regions of higher compression visualized in red) based on the one or more target compression values, intersecting the surface of the virtual mesh; and renders the virtual mesh including the colored gradient (e.g., via the user interface).

In another variation, the computer system can implement methods and techniques described above to: receive a user-specified target compression for a first region of the compression garment 100; and access a predefined target compression, different from the user-specified target compression, for a second target region, excluding the first target region, of the virtual mesh based on target characteristics for the second region. For example, the computer system can: receive selection of a first target compression of 25 mmHg for a forearm region of a compression sleeve; and access a second target compression of 15 mmHg for an elbow region of the compression sleeve, the second target compression based on a predefined target mobility for the elbow region.

Accordingly, the computer system can access custom compression targets for the compression garment 100 (or specific regions of the compression garment 100) to refine compression intensity based on: the compression garment type, such as a compression sock, sleeve, or full-body suit; the intended garment application, such as medical-grade compression for circulation improvement or athletic recovery support; and/or the target mobility requirements, such as reducing compression at joint regions to enable movement while maintaining compression in adjacent areas.

### 7. Centerline Derivation

Block S124 of the method S100 recites calculating an approximate centerline of the virtual mesh. Generally, the computer system can: calculate an approximate centerline of the virtual mesh in Block S124; and shrink the virtual mesh, in two dimensions, inward toward the approximate centerline to downsize the compression garment.

In one implementation, to calculate the approximate centerline of the virtual mesh the computer system can: identify normalized line segments representing directions of consistently oriented sections of the mesh (for instance, a foot and calf segment in a leg mesh), define a slicing axis based on the sum of these normalized line segments; and project a first set of planes onto the virtual mesh normal to the slicing axis. The computer system can then, for each plane in the first set of planes: detect a boundary of the virtual mesh intersecting the plane; calculate a centroid of the boundary; and project a center point, in a set of center points, into the virtual mesh at the centroid of the boundary. Based on the normalized line segments formed by sequentially connecting these center points as orthogonals, the computer system can project a second set of planes, recompute the intersections of the mesh and these planes, recompute the centroids, and hence achieve a refined center line. The computer system can then generate the approximate centerline including a smooth spline intersecting the set of center points projected into the virtual mesh.

### 8. Uniform Undersizing for Compression

Blocks of the method S100 recite: calculating an approximate centerline of the virtual mesh in Block S124; accessing a target compression for the compression garment 100 in Block S130; and radially downscaling the virtual mesh, radially about the approximate centerline, according to the target compression in Block S140. Generally, in Block S140, the computer system can downscale the virtual mesh, in two dimensions, based on a target compression (e.g., a uniform target compression) for the compression garment 100. In particular, the computer system can downscale the virtual mesh according to (e.g., proportional to) the target compression to reduce the surface area of the virtual mesh relative to the surface area of the target body surface.

More specifically, the computer system can project a second set of planes onto the virtual mesh and normal to the approximate centerline. For each plane in the second set of planes, the computer system can: detect a boundary of the virtual mesh intersecting the plane; and radially downscale the boundary of the virtual mesh (i.e., in two dimensions), within the plane, toward an intersection of the approximate centerline within the plane according to the target compression. More specifically, the computer system can shrink the boundary (i.e., the circumference) of each plane, in two dimensions, inward toward the approximate centerline of the virtual mesh. Thus, the computer system can downscale the virtual mesh according to the target compression, such that when the compression garment 100 is tensioned over the target body part, the compression garment 100 conforms to the target body part and exerts the target compression.

### 9. Non-uniform Undersizing for Compression

In one variation, the computer system can downscale discrete regions of the virtual mesh, in two dimensions, according to different compression targets. In particular, in this variation, the computer system can: access a first target compression for a first target region of the virtual mesh corresponding to a first region of the target body part; access a second target compression, different from the first target compression, for a second target region, different from the first target region, of the virtual mesh corresponding to a second region of the target body part; radially downscale the first target region of the virtual mesh, radially about the approximate centerline, proportional to the first target compression; and radially downscale the second target region of the virtual mesh, radially about the approximate centerline, proportional to the second target compression.

The computer system can then interpolate a smooth surface between the first target region and the second target region to prevent abrupt changes in compression intensity across the virtual mesh. In particular, the computer system can: define an intermediate transition region between the first target region and the second target region; interpolate a scaling factor between the first target compression and the second target compression; and radially downscale the intermediate region, radially about the approximate centerline, according to the scaling factor to smooth a transition between the first target region and the second target region.

In one example, the computer system: accesses a virtual mesh representing a lower leg; accesses a first target compression for a calf region of the virtual mesh based on a first target mobility for the calf region; and accesses a second target compression, less than the first target compression, for an ankle region of the virtual mesh based on a second target mobility, greater than the first target mobility, for the ankle region. The computer system then implements methods and techniques described above to: radially downscale the calf region of the virtual mesh proportional to the first target compression; radially downscale the ankle region of the virtual mesh proportional to the second target compression; and radially downscale an intermediate region of the virtual mesh, between the calf region and the ankle region, according to the scaling factor interpolated between the first target compression and the second target compression. Accordingly, the computer system can: downscale discrete regions of the virtual mesh based on different compression targets for these discrete regions; and smooth transitions between these discrete regions to prevent abrupt changes in compression intensity that may cause the user discomfort and/or induce stress concentrations, irregular deformation, or mechanical instability within the network of links 110.

### 10. Virtual Link Pattern

Block S150 of the method S100 recites constructing a network of tessellated cells intersecting a surface of the virtual mesh. Generally, in Block S150, the computer system can: construct a network of tessellated cells (e.g., approximating a centroidal Voronoi diagram); and project the network of tessellated cells onto a surface of the virtual mesh. In particular, the network of tessellated cells can define a pattern for arranging a network of virtual links on the virtual mesh. More specifically, each tessellated cell in the network of tessellated cells defines a boundary circumscribing the tessellated cell and defining a geometry and dimensions (e.g., an approximate radius) of the tessellated cell.

At each tessellated cell in the network of tessellated cells, a virtual primary link can be arranged over the tessellated cell such that the virtual primary link approximates a boundary of the tessellated cell. Thus, at each tessellated cell in the network of tessellated cells, the geometry and dimensions of the tessellated cell define the geometry and dimensions of the virtual primary link. Furthermore, the pattern defined by the network of tessellated cells can be translated into a real link pattern of a network of real links 110 forming the compression garment 100. Therefore, the computer system can define a network of tessellated cells arranged in a pattern exhibiting target pattern characteristics, such that a network of real links 110 constructed according to the pattern exhibits target mechanical properties (e.g., directional stiffness, or localized flexibility).

### 11. Iterative Tessellated Cell Refinement

Blocks of the method S100 recite: characterizing a set of distances between centroids of adjacent tessellated cells in the network of tessellated cells in Block S152; calculating a proportion of the set of distances that exceeds a threshold distance in Block S154; and, in response to the proportion of the set of distances exceeding a threshold proportion, reconstructing the network of tessellated cells in Block S150 (i.e., in order to reduce the proportion of the set of distances between centroids of adjacent tessellated cells in the network of tessellated cells exceeding a threshold proportion).

Generally, the computer system can iteratively refine the network of tessellated cells to achieve a network of tessellated cells exhibiting target pattern characteristics, such as an approximately uniform cell density, cell size, and cell geometry across the virtual mesh. In particular, the computer system can: characterize a set of distances between centroids of adjacent tessellated cells in the network of tessellated cells; calculate a proportion of the set of distances that exceed a threshold distance; and, in response to the proportion of the set of distances exceeding a threshold proportion, reconstruct the network of tessellated cells.

In one implementation, the computer system can: characterize a set of dimensions of each tessellated cell in the network of tessellated cells; and, in response to a dimension of a tessellated cell in the network of tessellated cells falling outside of a target dimension range, reconstruct the network of tessellated cells. The computer system can then iteratively repeat this process to construct a network of tessellated cells exhibiting target pattern characteristics. By refining the spacing and/or geometry of the network of tessellated cells, the computer system mitigates structural inconsistencies that may compromise garment integrity, induce stress concentrations, or result in unintended pressure variations across the compression garment 100. Thus, the computer system can iteratively refine the network of tessellated cells, such that a network of real links 110, constructed according to the network of tessellated cells, can be manufactured with structurally rigid materials while exhibiting a perceptible softness through finely distributed link geometries.

### 11.1 Iterative Tessellated Cell Refinement Based on Link Density

Blocks of the method S100 recite: for each tessellated cell in the network of tessellated cells, characterizing a secondary link density in Block S156; and, in response to a secondary link density of a tessellated cell in the network of tessellated cells deviating from a target link density range, reconstructing the network of tessellated cells in Block S150. Generally, as shown in FIG. 2, the computer system can iteratively refine the network of tessellated cells, such that a network of virtual links constructed according to the network of tessellated cells exhibits a target link arrangement. In particular, the computer system can iteratively refine the network of tessellated cells to achieve a link density within a target link density range for each tessellated cell. For example, the target link density range can represent: a target quantity of virtual secondary links linked to a particular virtual primary link (e.g., between five to seven virtual secondary links per virtual primary link); and/or a target offset between each secondary link linked to a particular virtual primary link.

In one variation, the computer system can virtually locate a virtual network of links 110 by, for each tessellated cell in the network of tessellated cells: virtually constructing a virtual primary link located within the tessellated cell; and virtually arranging a set of virtual secondary links linked to the virtual primary link. The computer system can then characterize a secondary link density corresponding to each tessellated cell in the network of tessellated cells. In particular, the computer system can characterize a secondary link density of the tessellated cell based on: a quantity of virtual secondary links in the set of virtual secondary links; and/or an offset distance between adjacent virtual secondary links in the set of virtual secondary links.

In another variation, the computer system can characterize a secondary link density of the tessellated cell: proportional to a count of edges of the tessellated cell; and/or inversely proportional to an area of the tessellated cell. In response to a secondary link density of a tessellated cell (or a set of tessellated cells) in the network of tessellated cells deviating from a target link density range, the computer system can reconstruct the network of tessellated cells.

By refining the secondary link density within the network of tessellated cells, the computer system mitigates structural instabilities that may arise from: excessive link clustering, which may generate high-density zones that restrict movement and compromise compression application; and/or insufficient link connectivity, which may cause excessive deformation or mechanical failure of the compression garment 100 when tensioning over the target body part. Thus, the computer system iteratively refines the network of tessellated cells, such that a network of real links 110, constructed according to the network of tessellated cells, exhibits target load distribution and deformation characteristics.

### 12. Three-Dimensional Model of Compression Garment

Block S170 of the method S100 recites generating a three-dimensional model of the compression garment 100. Generally, in Block S170, upon deriving the network of tessellated cells, the computer system can generate a three-dimensional model of the compression garment 100 including a network of virtual links constructed according to the pattern defined by the network of tessellated cells.

In one implementation, the computer system can generate a three-dimensional model of the compression garment 100 including: a constellation of virtual primary links, each virtual primary link in the constellation of virtual primary links located within a tessellated cell in the network of tessellated cells; and a constellation of virtual secondary links, each virtual secondary link in the constellation of virtual secondary links linking a pair of adjacent virtual primary links in the constellation of virtual primary links. In particular, each virtual primary link in the constellation of virtual primary links can define a toroidal geometry. More specifically, each virtual primary link can be characterized by a primary equatorial plane intersecting and parallel to a surface of a tessellated cell in the network of tessellated cells. By aligning the network of virtual primary links with the underlying body contours, the computer system generates the virtual primary links conforming to the curvature of the virtual mesh.

Furthermore, each virtual secondary link in the constellation of virtual secondary links: can intersect surfaces of a pair of adjacent tessellated cells in the network of tessellated cells; and can be characterized by a secondary equatorial plane perpendicular to surfaces of the pair of adjacent tessellated cells in the network of tessellated cells. More specifically, each virtual secondary link can define a surface offset from surfaces of the pair of adjacent virtual primary links by the manufacturing offset. More specifically, each virtual secondary link can maintain the manufacturing offset to prevent unintended fusing of links during printing of the compression garment 100.

### 13. Seam Location

In one variation, Blocks of the method S100 recite: defining a seam location on the virtual mesh, the seam location defining a region for excluding primary links and secondary links in Block S174; and injecting a constellation of virtual tertiary links into the three-dimensional model of the compression garment 100, each virtual tertiary link in the constellation of virtual tertiary links linked to primary links, in the constellation of virtual primary links, proximal the seam location in Block S176. In this variation, in Block S174, the computer system can define and/or receive selection of a seam location (e.g., a location for the closure mechanism) for the virtual mesh. In particular, the seam location can define a region proximal the seam location for excluding primary links and secondary links. Thus, the computer system can generate the three-dimensional model of the compression garment excluding virtual primary links and virtual secondary links from the three-dimensional model adjacent the seam location on the virtual mesh.

In this variation, the computer system can inject a constellation of virtual tertiary links into the three-dimensional model of the compression garment 100, each virtual tertiary link in the constellation of virtual tertiary links linked to primary links, in the constellation of virtual primary links, proximal the seam location (i.e., adjacent and offset from the seam location). More specifically, each virtual tertiary link can be configured to couple to a closure mechanism of the compression garment 100. Thus, the computer system can integrate virtual tertiary links near the seam location to facilitate attachment of the closure mechanism while preserving structural integrity and ensuring consistent load distribution across the network of links 110 during garment tensioning.

In particular, each virtual tertiary link can be configured to couple to a closure mechanism, such as a zipper, a dial-based tensioning system, or a lace-based system. In one example, the compression garment 100 includes a zipper configured to secure the garment over the target body part in a fully-tensioned configuration, wherein the zipper applies uniform radial compression by distributing tension evenly across the network of links 110 upon fastening.

In another example, the compression garment 100 includes a lace-based system configured to dynamically adjust the compression of the compression garment. In particular, a user may incrementally tighten or loosen the compression garment, via the lace-based system, to achieve a desired compression level. Additionally or alternatively, the user may incrementally tighten or loosen the compression garment, via the lace-based system, to achieve a desired compression level at a particular region of the compression garment by increasing a local hoop stress proximal to the region. Thus, the computer system can integrate virtual tertiary links proximal to the seam location to accommodate various closure mechanisms to generate a compression garment configured to exert immediate uniform compression or adjustable compression based on user-applied tension, while maintaining consistent load distribution across the network of links 110.

### 14. Garment Generation

Blocks of the method S100 recite: generating a print file representing the three-dimensional model of the compression garment 100 in Block S180; and printing the compression garment 100 according to the print file at an additive manufacturing system in Block S190. Generally, in Block S180, upon generating the three-dimensional model of the compression garment 100, the computer system can generate a print file for an additive manufacturing system (e.g., a selective laser sintering (SLS) system) to construct (i.e., print) a compression garment 100 according to the three-dimensional model.

Upon generating the print file, an additive manufacturing system can print the print file to construct the compression garment 100. In particular, the additive manufacturing system can print a network of real links 110 corresponding to the network of virtual links (e.g., virtual primary links, virtual secondary links, and/or virtual tertiary links), each real link in the network of real links 110 maintaining the manufacturing offset to prevent fusion between adjacent links in the network of real links 110.

### 14.1 Low-Energy State

In one variation, as shown in FIG. 1, the computer system can generate the print file representing the three-dimensional model (e.g., a mesh analog representation) in a low-energy (e.g., collapsed) state within a predefined, virtual print volume (e.g., a rectilinear virtual print volume) representing a print volume of the additive manufacturing system. In this variation, the computer system can: access a virtual print volume corresponding to a print volume of the additive manufacturing system; virtually locate (e.g., collapse) the three-dimensional model of the compression garment 100 into the virtual print volume in a low-energy state while maintaining the manufacturing offset; and generate a print file representing the three-dimensional model in the low-energy state.

For example, the computer system can: bias the three-dimensional model of the compression garment 100, virtually collapsed into the virtual rectilinear print volume, toward a minimum height within the virtual rectilinear print volume; and generate the print file according to a geometry of the three-dimensional model of the compression garment collapsed and biased toward a minimum height within the virtual rectilinear print volume. In this example, the computer system can access a virtual gravity model or physics-based simulation to bias the three-dimensional model of the compression garment 100, virtually collapsed into the virtual rectilinear print volume, toward a stable minimum-energy configuration. Thus, the computer system virtually locates the three-dimensional model of the compression garment 100 into the virtual print volume, such that the compression garment 100 is printed in a configuration that: minimizes printing time by printing the compression garment 100 to reduce unnecessary print head travel and layer transitions; and preserves the structural integrity of the compression garment 100 by maintaining spacing between links, preventing unintended fusion, and ensuring post-printing flexibility.

### 15. Multi-segment Compression Garment

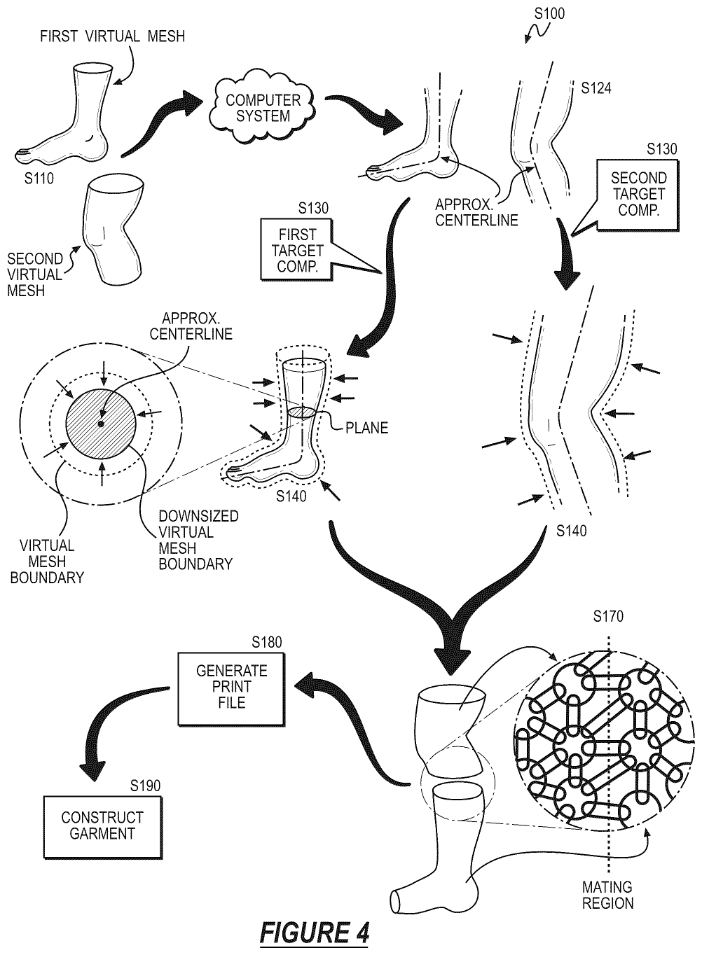

In one variation, as shown in FIG. 4, the system can generate multi-segment compression garments, such as a full-body suit (e.g., including a torso segment, an arm segment, and a leg segment), or a modular compression system (e.g., a sleeve and glove combination for upper limb compression therapy). In this variation, the computer system can implement methods and techniques described above to generate a first three-dimensional model of a first compression garment 100 (e.g., a compression sleeve) for a first target body part (e.g., an arm), the first compression garment 100 downscaled according to a first target compression. The computer system can then implement methods and techniques described above to: access a second virtual mesh representing a second target body part (e.g., a hand), adjacent the first target body part, for constructing a second compression garment 100 (e.g., a compression glove); downscale the second virtual mesh based on a second target compression for the second compression garment 100; and generate a second three-dimensional model of the second compression garment 100.

In particular, the second three-dimensional model can include: a constellation of virtual primary links; a first constellation of virtual secondary links, each virtual secondary link in the first constellation of virtual secondary links linking a pair of adjacent virtual primary links in the constellation of virtual primary links; and a second constellation of virtual secondary links, each virtual secondary link in the second constellation of virtual secondary links arranged along an edge of the second compression garment 100 configured to mate with the first compression garment 100. More specifically, each virtual secondary link in the second constellation of virtual secondary links can link a first virtual primary link in the constellation of virtual primary links of the first three-dimensional model, and a second virtual primary link, adjacent the first virtual primary link, in the constellation of virtual primary links of the second three-dimensional model. The computer system can then: implement methods and techniques described above to generate a print file representing the first three-dimensional model of the first compression garment 100 in a first low-energy state and the second three-dimensional model of the second compression garment 100 in a second low-energy state; and construct a multi-segment compression garment 100 including the first compression garment 100 and the second compression garment 100. Thus, the system can construct a complex, multi-segment compression garment 100 that is custom-fit to a particular user.

In one variation, the system can generate a modular compression garment including a set of discrete compression garments configured to affix to one another following construction of each discrete compression garment. In this variation, the computer system can generate a first three-dimensional model of a first compression garment 100 (e.g., a compression sleeve) for a first target body part (e.g., an arm), the first compression garment 100 downscaled according to a first target compression.

The computer system can then implement methods and techniques described above to: access a second virtual mesh representing a second target body part (e.g., a torso), adjacent the first target body part, for constructing a second compression garment 100 (e.g., a compression vest); downscale the second virtual mesh based on a second target compression for the second compression garment 100; and generate a second three-dimensional model of the second compression garment 100. In particular, in this variation, the second three-dimensional model can include: a constellation of virtual primary links; a constellation of virtual secondary links, each virtual secondary link in the constellation of virtual secondary links linking a pair of adjacent virtual primary links in the constellation of virtual primary links; and a constellation of virtual tertiary links, each virtual tertiary link in the constellation of virtual tertiary links linked to primary links, in the constellation of virtual primary links, proximal a seam location between the first compression garment 100 and the second compression garment 100.

The computer system can then: generate a print file representing the first three-dimensional model of the first compression garment 100 and the second three-dimensional model of the second compression garment 100; construct the first compression garment 100; and construct the second compression garment 100 (i.e., for later assembly with the first compression garment 100).

### 16. Compression Garment Applications

In one variation, the system can generate a garment that is not downsized for compression, such as a clothing item, a jewelry item, or a protective racing suit. In this variation, the computer system can implement methods and techniques described above to: access a virtual mesh representing a target body part (e.g., a wrist for a bracelet, a torso for a jacket, or a leg for a racing suit), for constructing a garment 100; downscale the virtual mesh according to the manufacturing offset between primary and secondary links of the garment; and generate a three-dimensional model of the garment 100. In particular, in this variation, the computer system does not downscale the virtual mesh according to a target compression for the garment 100 (i.e., the target compression is null) to generate a form-fitting but non-compressive garment 100. Thus, the system can construct garments 100 that conform to the target body part without applying compression to leverage the flexibility and structural properties of the network of links 110 for applications, such as fashion, protective gear, and accessories.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a virtual mesh representing a target body part;
downscaling the virtual mesh, in three dimensions, according to a manufacturing offset between primary links and secondary links of a compression garment, corresponding to the virtual mesh, during additive manufacturing of the compression garment;
calculating an approximate centerline of the virtual mesh;
accessing a target compression for the compression garment;
radially downscaling the virtual mesh, radially about the approximate centerline, according to the target compression;
constructing a network of tessellated cells intersecting a surface of the virtual mesh;
characterizing a set of distances between centroids of adjacent tessellated cells in the network of tessellated cells;
calculating a first proportion of the set of distances that exceed a threshold distance;
in response to the first proportion of the set of distances exceeding a threshold proportion, reconstructing the network of tessellated cells; and
generating a three-dimensional model of the compression garment comprising:
a first constellation of virtual primary links, each virtual primary link in the first constellation of virtual primary links:
defining a toroidal geometry; and
located within a tessellated cell in the network of tessellated cells; and
a second constellation of virtual secondary links, each virtual secondary link in the second constellation of virtual secondary links:
linking a pair of adjacent virtual primary links in the first constellation of virtual primary links; and
defining a surface offset from surfaces of the pair of adjacent virtual primary links by the manufacturing offset.

2. The method of claim 1, further comprising:
generating a print file representing the three-dimensional model of the compression garment; and
printing the compression garment according to the print file at an additive manufacturing system.

3. The method of claim 2, wherein generating the print file comprises:
accessing a virtual rectilinear print volume representing a print volume of the additive manufacturing system;
virtually collapsing the three-dimensional model of the compression garment into the virtual rectilinear print volume;
biasing the three-dimensional model of the compression garment, virtually collapsed into the virtual rectilinear print volume, toward a minimum height within the virtual rectilinear print volume; and
generating the print file according to a geometry of the three-dimensional model of the compression garment collapsed and biased toward a minimum height within the virtual rectilinear print volume.

4. The method of claim 1, wherein calculating the approximate centerline of the virtual mesh comprises:
identifying a first vertex and a second vertex arranged at a maximum separation distance in the virtual mesh;
defining an axis intersecting the first vertex and the second vertex;
projecting a set of planes onto the virtual mesh normal to the axis;
for each plane in the set of planes:
detecting a boundary of the virtual mesh intersecting the plane;
calculating a centroid of the boundary; and
projecting a center point, in a set of center points, into the virtual mesh at the centroid of the boundary; and
generating the approximate centerline comprising a spline intersecting the set of center points projected into the virtual mesh.

5. The method of claim 1, wherein radially downscaling the virtual mesh comprises:
projecting a set of planes onto the virtual mesh normal to the approximate centerline; and
for each plane in the set of planes:
detecting a boundary of the virtual mesh intersecting the plane; and
radially downscaling the boundary of the virtual mesh, within the plane, toward an intersection of the approximate centerline within the plane according to the target compression.

6. The method of claim 1, further comprising:
for each tessellated cell in the network of tessellated cells, characterizing a secondary link density:
proportional to a count of edges of the tessellated cell; and
inversely proportional to an area of the tessellated cell; and
in response to a first secondary link density of a first tessellated cell in the network of tessellated cells deviating from a target link density range, reconstructing the network of tessellated cells.

7. The method of claim 1:
further comprising:
accessing a set of images, of a region of a body, captured at a mobile device;
compiling the set of images into the virtual mesh;
cropping the virtual mesh to constrain the virtual mesh to surfaces corresponding to the target body part; and
defining a seam location on the virtual mesh;
wherein generating the three-dimensional model of the compression garment comprises generating the three-dimensional model of the compression garment comprises:
excluding virtual primary links and virtual secondary links from the three-dimensional model adjacent the seam location on the virtual mesh; and
further comprising injecting a third constellation of virtual tertiary links into the three-dimensional model of the compression garment, each virtual tertiary link in the third constellation of virtual tertiary links:
linked to primary links, in the first constellation of virtual primary links, proximal the seam location; and
adjacent and offset from the seam location.

8. The method of claim 1:
wherein accessing the target compression for the compression garment comprises accessing the target compression specifying:
a first target compression for a first target region of the virtual mesh corresponding to a first region of the target body part; and
a second target compression, different from the first target compression, for a second target region, different from the first target region, of the virtual mesh corresponding to a second region of the target body part; and
wherein radially downscaling the virtual mesh comprises:
radially downscaling the first target region of the virtual mesh, radially about the approximate centerline, proportional to the first target compression;
radially downscaling the second target region of the virtual mesh, radially about the approximate centerline, proportional to the second target compression;
interpolating a scaling factor between the first target compression and the second target compression; and
radially downscaling an intermediate region, between the first target region and the second target region, of the virtual mesh, radially about the approximate centerline, according to the scaling factor.

9. The method of claim 1:
wherein accessing the virtual mesh comprises accessing the virtual mesh representing the target body part comprising a lower leg;
wherein accessing the target compression comprises:
accessing the target compression for the compression garment comprising a compression sock, the target compression specifying:
a first target compression for a calf region of the virtual mesh; and
a second target compression, less than the first target compression, for an ankle region of the virtual mesh, the second target compression based on a second target mobility for the ankle region, the second target mobility greater than a first target mobility for the calf region; and
wherein radially downscaling the virtual mesh comprises:
radially downscaling the calf region of the virtual mesh, radially about the approximate centerline, proportional to the first target compression; and
radially downscaling the ankle region of the virtual mesh, radially about the approximate centerline, proportional to the second target compression.

10. The method of claim 1:
wherein accessing the target compression for the compression garment comprises accessing the target compression specifying a uniform target compression for the virtual mesh; and
wherein radially downscaling the virtual mesh comprises radially downscaling the virtual mesh, radially about the approximate centerline, proportional to the uniform target compression.

11. The method of claim 1, wherein generating the three-dimensional model of the compression garment comprises generating the three-dimensional model of the compression garment comprising:
the first constellation of virtual primary links, each virtual primary link in the first constellation of virtual primary links:
characterized by a primary equatorial plane intersecting and parallel to a surface of a tessellated cell in the network of tessellated cells; and
the second constellation of virtual secondary links, each virtual secondary link in the second constellation of virtual secondary links:
intersecting surfaces of a pair of adjacent tessellated cells in the network of tessellated cells; and
characterized by a secondary equatorial plane perpendicular to surfaces of the pair of adjacent tessellated cells in the network of tessellated cells.

12. A method comprising:
accessing a first virtual mesh representing a first target body part;
downscaling the first virtual mesh, in three dimensions, according to a manufacturing offset between primary links and secondary links of a first compression garment, corresponding to the first virtual mesh, during additive manufacturing of the first compression garment;
downscaling the first virtual mesh, in two dimensions, according to a first target compression for the first compression garment;
constructing a first network of tessellated cells intersecting a first surface of the first virtual mesh;
generating a first three-dimensional model of the first compression garment comprising:
a first constellation of virtual primary links, each virtual primary link in the first constellation of virtual primary links:
defining a toroidal geometry;
characterized by a primary equatorial plane intersecting and parallel to a surface of a tessellated cell in the first network of tessellated cells; and
located with the tessellated cell; and
a second constellation of virtual secondary links, each virtual secondary link in the second constellation of virtual secondary links:
intersecting surfaces of a pair of adjacent tessellated cell in the first network of tessellated cells; and
characterized by a secondary equatorial plane perpendicular to surfaces of the pair of adjacent tessellated cell in the first network of tessellated cells; and
generating a print file representing the first three-dimensional model of the first compression garment, the print file executable by an additive manufacturing system to construct the first compression garment.

13. The method of claim 12:
further comprising:
accessing a second virtual mesh representing a second target body part adjacent the first target body part;
downscaling the second virtual mesh, in three dimensions, according to the manufacturing offset;
downscaling the second virtual mesh, in two dimensions, based on a second target compression, different from the first target compression, for a second compression garment;
constructing a second network of tessellated cells intersecting a second surface of the second virtual mesh; and
generating a second three-dimensional model of the second compression garment comprising:
a third constellation of virtual primary links, each virtual primary link in the third constellation of virtual primary links:
defining a toroidal geometry;
characterized by a primary equatorial plane intersecting and parallel to a surface of a tessellated cell in the second network of tessellated cells; and
located within a tessellated cell in the second network of tessellated cells;
a fourth constellation of virtual secondary links, each virtual secondary link in the fourth constellation of virtual secondary links:
intersecting surfaces of a pair of adjacent tessellated cell in the second network of tessellated cells; and
characterized by a secondary equatorial plane perpendicular to surfaces of the pair of adjacent tessellated cell in the second network of tessellated cells; and
a fifth constellation of virtual secondary links, each virtual secondary link in the fifth constellation of virtual secondary links:
arranged along an edge of the second compression garment configured to mate with the first compression garment; and
linking:
a first virtual primary link in the first constellation of virtual primary links of the first three-dimensional model of the first compression garment; and
a second virtual primary link, adjacent the first virtual primary link, in the third constellation of virtual primary links of the second three-dimensional model of the second compression garment; and
wherein generating the print file comprises generating the print file representing the first three-dimensional model of the first compression garment and the second three-dimensional model of the second compression garment.

14. The method of claim 13:
wherein accessing the first virtual mesh comprises accessing the first virtual mesh representing the first target body part comprising an arm;
wherein accessing the second virtual mesh comprises accessing the second virtual mesh representing the second target body part comprising a hand
wherein downscaling the first virtual mesh in two dimensions comprises downscaling the first virtual mesh, in two dimensions, proportional to the first target compression comprising a first predefined target compression for a compression sleeve;
wherein downscaling the second virtual mesh in two dimensions comprises downscaling the second virtual mesh, in two dimensions, proportional to the second target compression comprising a second predefined target compression, different from the first predefined target compression, for a compression glove; and
wherein generating the print file comprises generating the print file representing the first three-dimensional model of the compression sleeve and the compression glove.

15. The method of claim 12:
wherein generating the print file comprises:
accessing a virtual print volume representing a print volume of the additive manufacturing system; and
virtually locating the first three-dimensional model of the first compression garment within the virtual print volume in a low-energy state while maintaining the manufacturing offset between surfaces of secondary links in the second constellation of virtual secondary links and surfaces of adjacent primary links in the first constellation of virtual primary links; and
further comprising, at the additive manufacturing system, executing the print file to construct a network of real links corresponding to the first constellation of virtual primary links and the second constellation of virtual secondary links, each real link in the network of real links maintaining the manufacturing offset to prevent fusion between adjacent links in the network of real links during execution of the print file.

16. The method of claim 12:
further comprising, via a user interface:
rendering the first virtual mesh;
prompting a user to indicate a seam location on the first virtual mesh; and
receiving selection of the seam location on the first virtual mesh from the user; and.
wherein generating the first three-dimensional model of the first compression garment comprises:
excluding virtual primary links and virtual secondary links from the first three-dimensional model adjacent the seam location on the first virtual mesh; and
generating the first three-dimensional model of the first compression garment further comprising:
a third constellation of virtual tertiary links, each virtual tertiary link in the third constellation of virtual tertiary links:
linked to primary links, in the first constellation of virtual primary links, proximal the seam location; and
configured to couple to a closure mechanism of the first compression garment.

17. The method of claim 12:
further comprising:
receiving selection of the first target compression for a first target region of the first virtual mesh;
accessing a third target compression, different from the first target compression, for a second target region of the first virtual mesh excluding the first target region, the third target compression based on a target mobility for the second target region; and
interpolating a scaling factor between the first target compression and the third target compression; and
wherein downscaling the first virtual mesh in two dimensions comprises:
downscaling the first target region of the first virtual mesh, in two dimensions, proportional to the first target compression;
downscaling the second target region of the first virtual mesh, in two dimensions, proportional to the third target compression; and
downscaling an intermediate region of the first virtual mesh, in two dimensions, based on the scaling factor to smooth a transition between the first target region and the second target region.

18. The method of claim 12, wherein downscaling the first virtual mesh in two dimensions comprises:
calculating an approximate centerline of the first virtual mesh;
projecting a set of planes onto the first virtual mesh normal to the approximate centerline; and
for each plane in the set of planes:
detecting a boundary of the first virtual mesh intersecting the plane;
locating an origin at an intersection of the plane and the approximate centerline; and
downscaling the boundary of the first virtual mesh, in two dimensions of the plane, toward the origin based on the first target compression.

19. The method of claim 12, further comprising, via a user interface:
rendering the first virtual mesh;
rendering a prompt to select the first target compression for the first virtual mesh; and
receiving the first target compression, for the first virtual mesh, annotated on the first virtual mesh rendered in the user interface.

20. A method comprising:
accessing a virtual mesh representing a target body part for generating a chainmesh garment;
accessing a target compression for the chainmesh garment;
downscaling the virtual mesh based on the target compression;
defining a seam location on the virtual mesh;
generating a three-dimensional model of the chainmesh garment including:
first constellation of virtual primary links, each virtual primary link in the first constellation of virtual primary links flush with a surface of the virtual mesh;
a second constellation of virtual secondary links, each virtual secondary link in the second constellation of virtual secondary links linking a pair of adjacent virtual primary links in the first constellation of virtual primary links; and
a third constellation of virtual tertiary links, each virtual tertiary link in the third constellation of virtual tertiary links linked to primary links, in the first constellation of virtual primary links, proximal the seam location; and
additively manufacturing the chainmesh garment according to the three-dimensional model.
